(19) United States
(12) Patent Application Publication
(10) Pub. No.: US 2008/0168677 A1
(43) Pub. Date: Jul. 17, 2008

(54) Razor drying device

(76) Inventor: Michael Lee Miller, Cary, NC (US)

Correspondence Address: MILLER PATENT SERVICES, 2500 DOCKERY LANE, RALEIGH, NC, 27606, US

(21) Appl. No.: 11/652,461

(22) Filed: Jan. 11, 2007

(51) Int. Cl. F26B 19/00

(52) U.S. Cl. 34/202

(57) ABSTRACT

In accordance with certain embodiments consistent with the present invention, a wet shaving razor blade drying apparatus has a housing. A chamber in the housing, suitable for receiving at least a bladed end of the wet shaving razor. A fan within the housing that causes air to pass over the bladed end of the wet shaving razor when the wet shaving razor is inserted into the chamber when the fan running. A switch switches on the fan when the wet shaving razor is inserted into the chamber. This abstract is not to be considered limiting, since other embodiments may deviate from the features described in this abstract.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Wet shaving razors come in several types including the disposable type (with single or multiple blades) or of the type using disposable blades. All such shaving razor's blades generally become dull and undesirable for use (or unusable) after several uses. The dullness of the blade is caused by several mechanisms. One mechanism is the actual abrasive effect of the blade cutting through hairs and rubbing against skin. Use of a razor inevitably produces this dulling effect.

A second mechanism has been discovered to result in effective dulling (or equivalent degradation of effectiveness) of the razor blade is corrosion and similar effects on the blade's surface and edge that occur after shaving when the blade is wet and left to air dry. While the first mechanism would appear to be unavoidable, this second mechanism is ameliorated by embodiments consistent with the present invention.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is an illustration of an exemplary embodiment of a razor blade dryer device consistent with certain embodiments of the present invention.

FIG. 2 is a more schematic illustration of an embodiment consistent with certain embodiments of the present invention.

FIG. 3 illustrates manual switching consistent with certain embodiments of the present invention.

FIG. 4 illustrates an embodiment of a mechanism for detection of presence of a razor within a compartment in a manner consistent with certain embodiments of the present invention.

FIG. 5 is an exemplary illustration of a block diagram of various embodiments consistent with certain embodiments of the present invention.

FIG. 6 is a flow chart depicting operation of a timer based embodiment consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The term “razor” may be used synonymously herein with the more technically accurate term “razor blade” or as a synonym for “shaver”, and the meaning will be readily discerned from one another upon consideration of the overall context. Embodiments consistent with the present invention are generally applicable to single or multiple edge razor blade carrying razors wherein the razor or razor blades are disposed of and replaced on a frequent basis (e.g., such as the those manufactured by Schick™ and Gillette™), rather than conventional electric shavers (such as those produced by Remington™, Panasonic™, Braun™, and Norelco™) and with foil head or rotating or reciprocating blades commonly used for dry shaving. However, the present invention is not precluded from use in conjunction with electric shaving devices that vibrate or otherwise move blades that are frequently replaced (e.g., every several days or weeks depending upon the user's beard, shaving habits and the like).

As previously indicated, dulling or equivalent degradation of effectiveness of a razor blade can occur as a result of corrosion, oxidization and similar effects on the blade's surface and edge that occur after shaving when the blade is wet and left to air dry. Such degradation can be minimized by thorough drying of the razor blade immediately after use (and rinsing). An apparatus consistent with embodiments of the present invention can be utilized to minimize such effects. In addition, according to certain embodiments, the risk of accidental cutting is reduced along with the likelihood of infection when accidental nicks and cuts do occur.

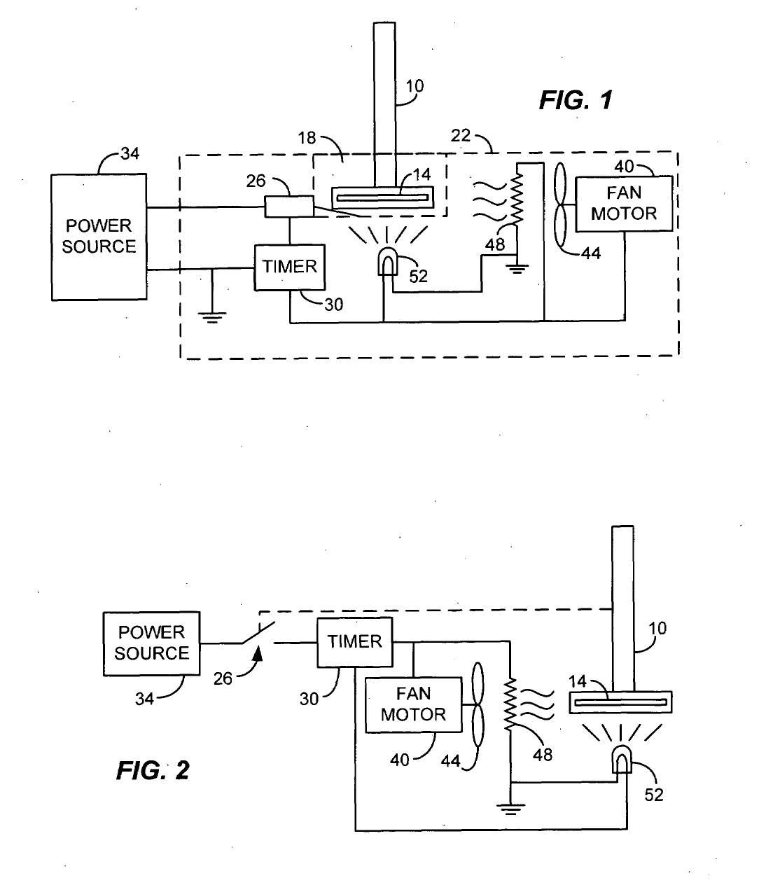

FIG. 1, depicts one embodiment consistent with the present invention in which a wet shaving razor 10 having razor blade 14 is inserted into a compartment 18 of a housing or enclosure 22 that is suitably sized and shaped to readily accept the cutting end of the razor 10. In this embodiment, upon insertion of the shaving razor 10 into compartment 18, a switch 26 (such as a commercially available pressure or weight sensitive switch) is closed to provide power to (or simply to trigger initiation of) a timer 30 from a power source 36 (AC, DC, household current, battery or transformer supplied, for example). Due to high potential use in wet environments, it is preferred that the device depicted be supplied by a power source that uses a ground fault interrupter (GFI) circuit for safety. Switch 26, as depicted has a lever arm that is moved from a first position urged upward by a low spring constant spring, such that the weight of the razor itself is adequate to cause the switch to change state (Embodiments can be devised that operate either by opening or closing of the switch upon actuation by the weight of the razor. Timer 30 may, for example, initiate a drying cycle of approximately 3 minutes, but this should not be considered limiting since the time will depend upon a number of factors, and may range, for example from about 2 minutes to about 10 minutes (with great variation as will be explained below.

When the timer 30 is initiated, a drying operation commences and lasts for the duration of the timed drying cycle. This drying operation can be carried out in a number of ways, but in a preferred embodiment, generally a fan motor 40 driving fan blades 44 or other air flow generation mechanism is initiated. In certain embodiments, the flow of air alone creates the drying effect in an economical embodiment without the addition of other drying elements. In the present embodiment, in addition to a fan blowing air across the razor blade 14, a heater element 48 such as a resistive heating element is similarly engaged at the time of initiating the timing cycle. The addition of heat via heater element 48 can be used to accelerate the drying cycle. However, it should be noted that wet shaving razors are generally used by only a single individual, and generally no more often than about once per day. Hence, the speed of operation of the drying cycle may be less important than other factors to consider in any given design. Also in this embodiment, a sanitizing device such as an ultraviolet light 52 is turned on during the timing cycle. Other sanitizing devices such as those that initially spray the razor with a mist of alcohol or other antiseptic, or that generate ozone may also be implemented.

Hence, once the timing cycle is initiated, in this case by insertion of the razor 10 into the compartment 18, the fan motor 40 is engaged to blow or draw air past the razor blade 14 to begin the drying process. In this embodiment, the heater element 48 is also turned on to heat the air passed by the razor blade 14 to accelerate the drying process. Also, the blade is exposed to ultraviolet light from light 52 or sanitized by any other suitable sanitizing device. Depending upon the amount of air flow and heat level generated, the time for the timing cycle can be determined experimentally to provide a suitable level of drying of the razor blade 14.

At this point, it is noted that various combinations of the components depicted in FIG. 1 are possible without departing from embodiments consistent with the present invention. For example, the fan can be used without the heater element and with or without a sanitizing mechanism such as an ultraviolet light. Or, the heater element can be used with or without the sanitizer and fan. Further, the timer may be manually overridden, adjustable or omitted. While it is preferred to utilize an electrical or mechanical timer device so that the razor can be dried for a specified time after insertion into the compartment, a fully manual embodiment is also contemplated. In such an embodiment, a manually operated switch is actuated to engage any one or any combination of fan, heater and/or sanitizer, and allowed to run until manually disabled. Other embodiments will occur to those skilled in the art upon consideration of the present teachings.

FIG. 2 depicts the same embodiment as shown in FIG. 1 in a more schematic representation. Again, in this embodiment, once the timing cycle is initiated, for example by insertion of the razor 10 into the compartment 18, the fan motor 40 is engaged so that the fan blades blow or draw air past the razor blade 14 to begin the drying process. In this embodiment, the heater element 48 is also turned on to heat the air passed by the razor blade 14 to accelerate the drying process. Also, the blade 14 is exposed to ultraviolet light from light 52 or sanitized by any other suitable sanitizing device. Depending upon the amount of air flow and heat level generated, the time for the timing cycle can be determined experimentally to provide a suitable level of drying of the razor blade 14.

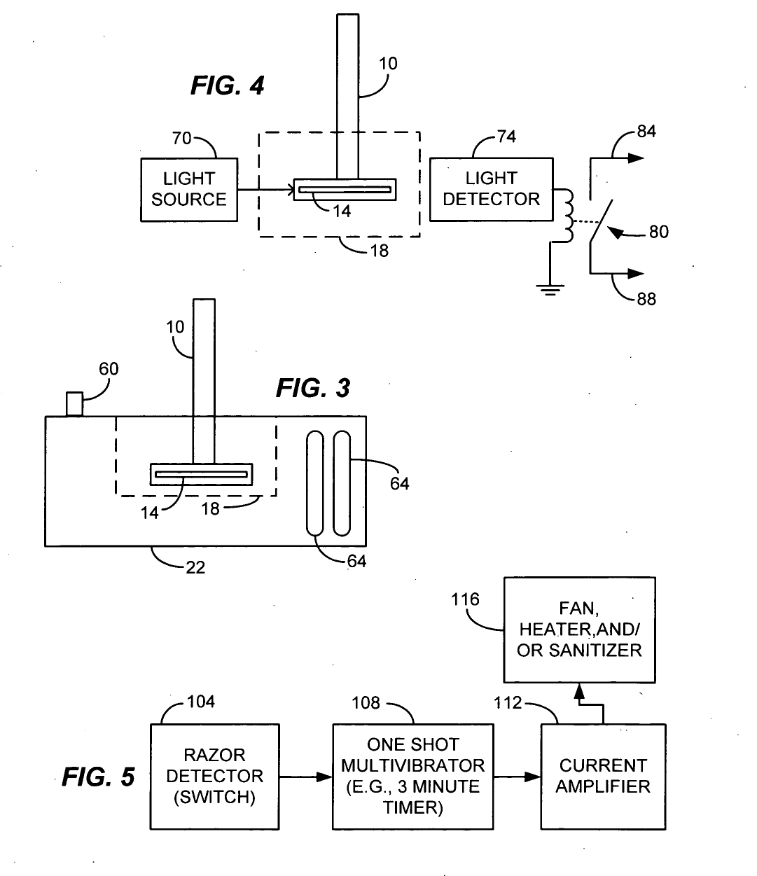

FIG. 3 depicts an alternative embodiment in part, wherein a manual switch (button or toggle switch) 60 is used to either initiate a timed cycle or to manually turn on and off the operation of the drying and/or sanitizing components—in lieu of an automatic initiation of the cycle upon insertion of the razor 10 into compartment 18. In this illustration vents 64 are shown in the housing 22 to permit free flow of air, and it should be understood that vents or other air flow mechanisms should be provided to permit and/or facilitate air to flow across the razor blade 10 so as to facilitate evaporation of the moisture residue on the blade 10.

Referring now to FIG. 4, an alternative mechanism can be used to detect the presence of a razor 10 in the compartment 18. In this embodiment, a light source such as a light emitting diode or the like 70 projects a beam of light across compartment 18 and is received by light detector 74 (such as any suitable light sensitive semiconductor switching device or resistive device). When a razor 10 is inserted into the compartment 18, the light beam is broken which signifies that the razor 10 is in the compartment. This can be used to initiate a timing cycle or turn on fan, heater or sanitizer as desired. In this embodiment, detection of the broken beam can be used to trip a relay (mechanical or electronic) 80 to either supply power to the remaining circuitry via connections 84 and 88 or to directly begin a timing cycle for circuitry powered in any suitable manner.

FIG. 5 depicts a high level block diagram of one embodiment of the circuitry used in various embodiments consistent with the present invention. In this depiction, a razor detector 104 detects the presence of a razor 10, or alternatively, a manual switch is actuated. In this embodiment, a timer 108 which may be devised using conventional circuit design techniques is initiated. In one embodiment, this can be realized using a one-shot multivibrator or counter circuit can be devised (e.g., using an industry standard 555 timer based one-shot circuit). Upon initiation of the timing cycle a current source or current amplifier (e.g., a relay or transistor based current amplifier, or switching circuit) 112 is engaged to supply power to any or all of a fan, heater, and/or sanitizer device 116. In this example, the timing cycle lasts for approximately three minutes, after which time the circuit is broken to the fan, heater and/or sanitizer device 116.

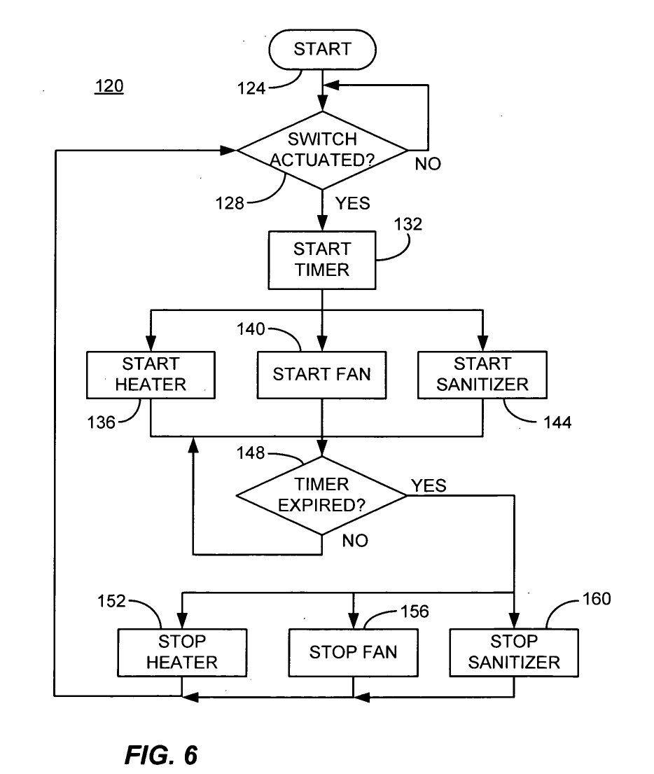

FIG. 6 depicts a process flow chart for operation of embodiments consistent with the present invention. Although shown in hardware elements in the prior drawing figures, embodiments consistent with the present invention can also be implemented using an electronic processing device operating according to the present flow chart depicting process 120, starting at 124. At 128, the status of a switch is monitored to detect insertion of a razor 10 into compartment 18, or to indicate manual initiation of the drying cycle. Once a switch actuation is detected at 128, the timing cycle is initiated at 132. At the initiation of this timing cycle, a heater is started at 136, a fan is started at 140 and a sanitizer is initiated at 144. In certain embodiments, any one or two or all of these actions 136, 140 and/or 144 can be initiated, without limitation. Once the cycle is started, the timer expiration at 148 halts the operation of any or all of the actions initiated at 136, 140 and/or 144 at 152, 156 and/or 160. Of course, in a manual embodiment, the timer initiation at 132 and halting at 148 is omitted and execution of the timing cycle is strictly manual with the turning on and turning off of the heater, fan and/or sanitizer are strictly manually controlled.

Thus, in accordance with certain embodiments consistent with the present invention, a wet shaving razor blade drying apparatus has a housing. A chamber in the housing, suitable for receiving at least a bladed end of the wet shaving razor. A fan within the housing that causes air to pass over the bladed end of the wet shaving razor when the wet shaving razor is inserted into the chamber when the fan running. A switch switches on the fan.

In certain embodiments, the switch can be a mechanical or optical switch that is actuated when the wet shaving razor is inserted into the chamber. In certain embodiments the switch can be an electrical switch that is manually actuated to switch on the fan. In certain embodiments, a heater responsive to actuation of the switch heats the air that passes over the bladed end of the wet shaving razor. In certain embodiments, a timer is responsive to the switch and couples power to the fan and the heater so that the fan runs and the heater heats for a time period after the switch is actuated and then turns the power to the fan and/or heater off. In certain embodiments, a timer is responsive to the switch and couples power to the fan so that the fan runs for a time period after the switch is actuated and then turns the power to the fan off. In certain embodiments, a source of ultraviolet light is responsive to actuation of the switch to provide ultraviolet light to the bladed end of the wet shaving razor. In certain embodiments, the housing is vented to permit the free flow of air when the fan is running.

In certain embodiments, a wet shaving razor drying apparatus has a housing. A chamber is provided in the housing, suitable for receiving at least a bladed end of the wet shaving razor. A fan within the housing causes air to pass over the bladed end of the wet shaving razor when the wet shaving razor is inserted into the chamber and the fan is running. A heater heats the air that passes over the bladed end of the wet shaving razor. A switch switches on the fan and the heater.

In certain embodiments, the switch is actuated when the wet shaving razor is inserted into the chamber. In certain embodiments, the switch can be an electrical switch that is manually actuated to switch on the fan. In certain embodiments, a timer is responsive to the switch and couples power to the fan and the heater so that the fan runs and the heater heats for a time period after the switch is actuated and then turns the power to the fan and heater off. In certain embodiments, a source of ultraviolet light is responsive to actuation of the switch for providing ultraviolet light to the bladed end of the wet shaving razor. In certain embodiments, the housing is vented to permit the free flow of air when the fan is running.

In certain embodiments, a wet shaving razor drying apparatus has a housing with a chamber in the housing suitable for receiving at least a bladed end of the wet shaving razor. A heater heats the bladed end of the wet shaving razor when the heater is on and the wet shaving razor is inserted into the chamber. A switch switches on the heater. In certain embodiments, the switch is actuated when the wet shaving razor is inserted into the chamber. In certain embodiments, the switch can be an electrical switch that is manually actuated to switch on the heater. In certain embodiments, a timer is responsive to the switch and couples power to the heater so that the heater heats for a time period after the switch is actuated and then turns the power to the heater off. In certain embodiments, a source of ultraviolet light responsive to actuation of the switching means for providing ultraviolet light to the bladed end of the wet shaving razor.

In certain embodiments, a wet shaving razor drying apparatus has a vented housing. A chamber is provided in the housing, suitable for receiving at least a bladed end of the wet shaving razor. A fan within the housing causes air to pass over the bladed end of the wet shaving razor when the wet shaving razor is inserted into the chamber and when the fan is running. A heater heats the air that passes over the bladed end of the wet shaving razor. A switch is provided with a timer being responsive to the switch to couple power to the fan and the heater so that the fan runs and the heater heats for a time period after the switch is actuated and then turns the power to the fan and heater off, wherein the switch is actuated when the wet shaving razor is inserted into the chamber. In certain embodiments, a source of ultraviolet light is responsive to actuation of the switch to provide ultraviolet light to the bladed end of the wet shaving razor.

In certain embodiments, a wet shaving razor blade drying apparatus has a housing with a chamber in the housing, suitable for receiving at least a bladed end of the wet shaving razor. A drying process is initiated when the bladed end of the wet shaving razor is within the chamber. A dryer within the housing dries the blade of the wet shaving razor during the drying process.

In certain embodiments, a process for drying a wet shaving razor blade is carried out by detection of a switch actuation (e.g., representative of insertion of a razor into a dryer device's compartment). A timer cycle may be initiated upon detection of the switch actuation and while the timer cycle is in place, a fan, heater and/or sanitizing element can be turned on, with the end of the cycle resulting in turning off the fan, heater and/or sanitizing element.

Hence, by use of embodiments consistent with the present invention, dulling or equivalent degradation of effectiveness of a razor blade that occurs as a result of corrosion, oxidization and similar effects on the blade's surface and edge can be reduced by thorough drying of the razor blade immediately after use (and rinsing). In addition, according to certain embodiments, the risk of accidental cutting is reduced along with the likelihood of infection when accidental nicks and cuts do occur. Emperical testing, using shaving closeness and comfort as criteria, has established that the blade life of a razor blade dried immediately after use increases substantially on the razors tested.

It is noted that various combinations of components depicted are possible without departing from embodiments of the present invention. For example, the fan can be used without the heater element and with or without a sanitizing mechanism such as an ultraviolet light. Or, the heater element can be used with or without the sanitizer and fan. Further, the timer may be manually overridden, adjustable or omitted. In one embodiment, the timer can be omitted and the fan operates continuously until the razor 10 is within the compartment 18. While it is preferred to utilize an electrical or mechanical timer device, so that the razor can be dried for a short specified time after insertion into the compartment, a fully manual embodiment is also contemplated. In such an embodiment, a manually operated switch is actuated to engage any one or any combination of fan, heater and/or sanitizer, and allowed to run until manually disabled. Other embodiments will occur to those skilled in the art upon consideration of the present teachings.

While certain embodiments herein were described in conjunction with specific circuitry that carries out the functions described, other embodiments are contemplated in which the circuit functions are carried out using equivalent software or firmware embodiments executed on one or more programmed processors. General purpose computers, microprocessor based computers, micro-controllers, optical computers, analog computers, dedicated processors, application specific circuits and/or dedicated hard wired logic and analog circuitry may be used to construct alternative equivalent embodiments. Other embodiments could be implemented using hardware component equivalents such as special purpose hardware and/or dedicated processors programmed to carry out the functions described.

While certain illustrative embodiments have been described, it is evident that many alternatives, modifications, permutations and variations will become apparent to those skilled in the art in light of the foregoing description.

1. A wet shaving razor blade drying apparatus, comprising:
a housing;
a chamber in the housing, suitable for receiving at least a bladed end of the wet shaving razor;
a fan within the housing that causes air to pass over the bladed end of the wet shaving razor when the wet shaving razor is inserted into the chamber when the fan running;
a sanitizing device for sanitizing the blade; and
a switch that switches on the fan and the sanitizing device.

2. The apparatus according to claim 1, wherein the switch is actuated when the wet shaving razor is inserted into the chamber.

3. The apparatus according to claim 1, wherein the switch comprises a mechanical or optical switch that is actuated when the wet shaving razor is inserted into the chamber.

4. The apparatus according to claim 1, wherein the switch comprises an electrical switch that is manually actuated to switch on the fan.

5. The apparatus according to claim 1, further comprising a heater responsive to actuation of the switch that heats the air that passes over the bladed end of the wet shaving razor.

6. The apparatus according to claim 5, further comprising a timer responsive to the switch and coupling power to the fan and the heater so that the fan runs and the heater heats for a time period after the switch is actuated and then turns the power to the fan off.

7. The apparatus according to claim 1, further comprising a timer responsive to the switch and coupling power to the fan so that the fan runs for a time period after the switch is actuated and then turns the power to the fan off.

8. The apparatus according to claim 1, wherein the sanitizing device comprises a source of ultraviolet light responsive to actuation of the switch for providing ultraviolet light to the bladed end of the wet shaving razor.

9. (canceled)

10. The apparatus according to claim 1, wherein the housing is vented to permit the free flow of air when the fan is running.

11. A wet shaving razor drying apparatus, comprising:
a housing;
a chamber in the housing, suitable for receiving at least a bladed end of the wet shaving razor;
a fan within the housing that causes air to pass over the bladed end of the wet shaving razor when the wet shaving razor is inserted into the chamber and the fan is running;
a heater that heats the air that passes over the bladed end of the wet shaving razor;
a sanitizing device for sanitizing the blade; and
a switch that switches on the fan and the sanitizing device.

12. The apparatus according to claim 11, wherein the switch is actuated when the wet shaving razor is inserted into the chamber.

13. The apparatus according to claim 11, wherein the switch comprises an electrical switch that is manually actuated to switch on the fan.

14. The apparatus according to claim 11, further comprising a timer responsive to the switch and coupling power to the fan and the heater so that the fan runs and the heater heats for a time period after the switch is actuated and then turns the power to the fan and heater off.

15. The apparatus according to claim 11, wherein the sanitizing device comprises a source of ultraviolet light responsive to actuation of the switch for providing ultraviolet light to the bladed end of the wet shaving razor.

16. (canceled)

17. The apparatus according to claim 11, wherein the housing is vented to permit the free flow of air when the fan is running.

18. A wet shaving razor drying apparatus, comprising:
a housing;
a chamber in the housing, suitable for receiving at least a bladed end of the wet shaving razor;
a heater that heats the bladed end of the wet shaving razor when the heater is on and the wet shaving razor is inserted into the chamber;
a switch that switches on the heater.
a sanitizing device for sanitizing the blade; and
a switch that switches on the fan and the sanitizing device.

19. The apparatus according to claim 18, wherein the switch is actuated when the wet shaving razor is inserted into the chamber.

20. The apparatus according to claim 18, wherein the switch comprises an electrical switch that is manually actuated to switch on the heater.

21. The apparatus according to claim 18, further comprising a timer responsive to the switch and coupling power to the heater so that the heater heats for a time period after the switch is actuated and then turns the power to the heater off.

22. The apparatus according to claim 18, wherein the sanitizing device comprises a source of ultraviolet light responsive to actuation of the switching means for providing ultraviolet light to the bladed end of the wet shaving razor.

23. A wet shaving razor drying apparatus, comprising:
a vented housing;
a chamber in the housing, suitable for receiving at least a bladed end of the wet shaving razor;
a fan within the housing that causes air to pass over the bladed end of the wet shaving razor when the wet shaving razor is inserted into the chamber and when the fan is running;
a heater that heats the air that passes over the bladed end of the wet shaving razor;
a switch;
a sanitizing device for sanitizing the blade; and
a timer responsive to the switch and coupling power to the fan, the sanitizing device, and the heater so that the fan runs, the sanitizing device sanitizes, and the heater heats for a time period after the switch is actuated and then turns the power to the fan, the sanitizing device, and heater off, wherein the switch is actuated when the wet shaving razor is inserted into the chamber.

24. The apparatus according to claim 23, wherein the sanitizing device comprises a source of ultraviolet light responsive to actuation of the switch for providing ultraviolet light to the bladed end of the wet shaving razor.

25. A wet shaving razor blade drying apparatus, comprising:
a housing;
a chamber in the housing, suitable for receiving at least a bladed end of the wet shaving razor;
means for initiating a drying process when the bladed end of the wet shaving razor is within the chamber;
sanitizing means within the housing for sanitizing the blade during the drying process; and
drying means within the housing that dries the blade of the wet shaving razor during the drying process.
